(19) United States
(12) Patent Application Publication
(10) Pub. No.: US 2025/0320077 A1
(43) Pub. Date: Oct. 16, 2025

(54) WORKING SUPPORT FOR LASER CUTTING AND CONVEYOR BELT WITH WORKING SUPPORT

(71) Applicant: SEI S.P.A., Curno (BG) (IT)

(72) Inventor: Ettore FUSTINONI, Curno (BG) (IT)

(21) Appl. No.: 19/169,369

(22) Filed: Apr. 3, 2025

(30) Foreign Application Priority Data
Apr. 11, 2024 (EP) 24169813.3

(51) Int. Cl. B65H 5/22; B23K 37/04; B41J 11/00; B41J 13/08

(52) U.S. Cl. CPC B65H 5/224; B23K 37/0408; B41J 11/0085; B41J 13/08; B65H 2406/32; B65H 2701/1944

(57) ABSTRACT

The present invention provides a working support (10) and a conveyor belt (100) comprising the working support (10) for a laser cutting and/or marking operation. The working support (10) includes at least one vacuum chamber (1) fluidically connected to at least one vacuum element (2), a honeycomb structure (3) comprising a plurality of cells (30) and disposed spaced from the vacuum chamber (1), and an intermediate depression chamber (21) disposed between the honeycomb structure (3) and the vacuum chamber (1). The lower surface (22) of the intermediate depression chamber (21) has a plurality of suction holes (13) which fluidically connect the vacuum chamber (1) with the cells (30) of the honeycomb structure (3). The upper surface (33) of the honeycomb structure (3) comprises ridges and depressions and the honeycomb structure may consist of a plurality of corrugated metal sheets welded together.

### RELATED APPLICATION

This application is related to and claims priority to European Application EP24169813 entitled “Working Support for Laser Cutting and Conveyor Belt comprising Working Support” filed 11 Apr. 2024, the contents of which are hereby incorporated by reference as if set forth in their entirety.

### FIELD OF THE INVENTION

The present invention relates to the field of handling, supporting and holding sheet material, such as but not limited to paperboard, carton, cardboard and corrugated cardboard, during laser cutting and/or marking operations.

### BACKGROUND OF THE INVENTION

Laser cutting in the paper industry, and in particular in the field of carton, cardboard, cartonboard, corrugated cardboard, corrugated carton, and in general on thick paper sheet material, uses a focused high-power density laser beam to irradiate the sheet material, to quickly cut the sheet material. Vacuum platforms or tables are used, by exploiting the vacuum principle to firmly hold sheet materials against the working support during processing. However, existing vacuum platforms, especially in field of paper industry, do not achieve an efficient and homogeneous vacuum or depression. As will be better discussed in the following, existing vacuum platforms do not satisfy various needs, among which a high and homogeneous depression, efficient evacuation of fumes, dust and smokes, negligible laser power reflections which would otherwise affect the final product.

The traditional vacuum working platforms for laser cutting comprise honeycomb structures as the one shown in FIG. 1A, directly arranged above a vacuum chamber (FIG. 1B), or arranged on a flat platform provided with holes (FIG. 1C) above a vacuum chamber, which is connected to the vacuum generating elements through holes and air path connectors.

This may result in inefficient or uneven suction, thus affecting the processing accuracy of the workpiece.

An uneven and inhomogeneous suction can lead to unwanted displacement of the sheet during the cutting process.

Furthermore, when the sheet material to be cut is a sheet of corrugated cardboard (which can be up to 15 mm thick), it can be laid on the platform in a configuration that is not completely flat (as would be desirable for optimal processing), since it may be arranged on the vacuum platform with unwanted folds, or it may have been deformed, e.g. during transport or packaging operations, and take on an unwanted curvature, which makes the sheet material unsuitable for precise cutting operations.

Furthermore, during the cutting process, fumes, exhaust gas and cutting waste will be generated. However, most of the current vacuum working platforms for laser cutting, as those schematically shown in FIGS. 1B and 1C do not efficiently remove fumes, exhaust gas and cutting waste.

It is found that known art has the following disadvantages.

The fumes, dust and exhaust gas generated will directly affect the working environment and the sheet material to be cut, and are harmful for the health of workers.

Fumes that are not effectively removed will affect sheet material, generating blackening and smoke contamination of the environment, affecting the quality of the final product.

Consequently, frequent shutdowns are required for cleaning fumes residuals, which not only affects product processing efficiency, but also is tiring work for an operator, time-consuming and expensive, since the cost of manual waste cleaning is also high.

Furthermore, during the traditional cutting process, reflections of the laser beam are generated. However, most of the current vacuum working platforms for laser cutting as those schematically shown in FIGS. 1B and 1C, do not efficiently disperse reflected radiation, which is reflected directly onto the material being processed, causing unwanted burns.

### SUMMARY

It is thus an object of the present invention to provide a solution to the above-mentioned problem.

It is in particular an object of the present invention to provide a solution that provides a precise and accurate positioning and flattening of the sheet material during laser cut.

It is another object of the present invention to provide a working support that allows laser cutting on carton, paperboard, cardboard, corrugated cardboard, and in general on thick paper sheet material while minimizing possible blackening caused by fumes produced by the cutting operation itself.

It is another object of the present invention to provide a working support that allows laser cutting on carton, paperboard, cardboard, corrugated cardboard, and in general on thick paper sheet material while minimising possible burns caused by possible reflections of the laser beam.

It is another object of the present invention to provide the above-mentioned solution in a manner that can be implemented also in existing machines. It is also an object of the present invention to provide a machine (or system) for cutting bi-dimensional objects from sheet material, allowing a precise and accurate positioning of the obtained bi-dimensional objects.

These and other objects are achieved by the present solution according to one or more of the enclosed claims.

Objects of the present invention are in particular a working support and a conveyor belt comprising the working support, for handling, supporting and holding sheet material, such as carton, paperboard, cardboard, corrugated cardboard, and in general thick paper sheet material, during laser cutting and/or marking operation, and a machine comprising such a conveyor belt, according to the claims. Various other aspects are recited in dependent claims. The present invention is directed to a working support for laser cutting and/or marking operation, comprising: at least one vacuum chamber connected to at least one vacuum element; a honeycomb structure comprising a plurality of cells, which is arranged spaced from the vacuum chamber; and an intermediate depression chamber disposed between the honeycomb structure and the vacuum chamber. The lower surface of the intermediate depression chamber has a plurality of suction holes which fluidically connect the vacuum chamber with the cells of the honeycomb structure.

Compared to devices known in the art, the presence of an intermediate depression chamber advantageously provides for avoiding stagnation of fumes generated by the laser cutting, thanks to better and more uniform ventilation below the honeycomb structure. The presence of an intermediate chamber makes it possible to generate an air flow that circulates in a linear manner, without creating turbulence or stagnation of fumes below the honeycomb structure.

Furthermore, the presence of suction holes advantageously allows for rapid and effective evacuation of fumes.

According to an aspect, the lower surface of said intermediate depression chamber is made of metallic material, or in general can be made of a material capable of managing the waste energy of the laser, in particular to reflect the residual radiation of the laser beam in such a manner to disperse it. For example, the lower surface of said intermediate depression chamber can be made of aluminium or steel.

Advantageously, the lower surface of the intermediate depression chamber may be made of metallic material, or of a material capable of reflecting the residual radiation of the laser beam, allowing for the dispersal of the reflections of the laser beam and its excess radiation, which passes through the sheet material being processed and is reflected on the lower surface of the intermediate chamber.

In this way, the reflected radiation is dispersed to avoid reflection towards the sheet material being processed, which would lead to unwanted burning or blackening.

According to an aspect, the honeycomb structure is made of metallic material, advantageously aluminium or steel.

According to an aspect, the upper surface of the honeycomb structure comprises ridges and depressions such that the upper profile of the honeycomb structure is one of ridges and depressions.

Advantageously, compared to devices known in the art, the presence of a honeycomb structure with an upper surface provided with ridges and depressions allows the material being processed to be not entirely in contact with, i.e. not completely adhering to the honeycomb structure, and the space generated by the presence of ridges and depressions allows a linear and continuous air flow to be maintained, which avoids turbulence and stagnation of fumes, contrary to known techniques, where the honeycomb structure has a flat upper surface (a flat support surface for the sheet material).

Furthermore, advantageously, the presence of a honeycomb structure with an upper surface provided with ridges and depressions minimizes laser reflections because of the negligible area of supporting points (the ridges) of the sheet to be processed.

According to an aspect, the lower surface of the intermediate depression chamber has a cross-section with a wavy or sinusoidal profile.

According to an aspect, the lower surface of the intermediate depression chamber comprises a plurality of rectilinear grooves, parallel to each other. Advantageously, the wavy configuration of the lower surface of the intermediate depression chamber allows for the dispersal of the reflections of the laser beam and its excess radiation, which passes through the sheet material being processed and is reflected on the lower surface of the intermediate chamber. In this way, the reflected radiation is dispersed to avoid reflection towards the sheet material being processed, which would lead to unwanted burning or blackening.

According to an aspect, the honeycomb structure comprises a plurality of corrugated metal sheets welded together.

According to this aspect, each metal sheet has an upper profile provided with ridges and depressions, and a straight lower profile.

According to an aspect, the working support comprises a spacer and support member to support the honeycomb structure such that the lower surface of the honeycomb structure is arranged at a distance from the lower surface of the intermediate depression chamber.

Advantageously, the presence of spacer and support means allows to provide for an intermediate depression chamber, taking the above-mentioned advantages to generate an air flow that circulates in a linear manner, without creating turbulence or stagnation of fumes below the honeycomb structure. The present invention is further directed to a conveyor belt for handling, supporting and holding sheet material, such as but not limited to carton, paperboard, cardboard, corrugated cardboard, and in general thick paper sheet material, during laser cutting and/or marking operation, the conveyor belt comprising a plurality of interconnected slats arranged parallel to each other, wherein each slat comprises a working support according to the invention, connected to at least one vacuum element configured to provide air suction from the environment, to provide a holding force to draw and hold said sheet material.

Advantageously, a conveyor belt provided with such a working support allows for a precise and accurate positioning of the sheet material to be cut, avoiding unintentional movement of the sheet during laser processing, and increasing productivity.

Advantageously, the conveyor belt can be implemented also in existing machines.

According to an aspect, each slat is provided with connection elements provided with connection means for interconnection with adjacent slats.

According to an aspect, the connection members of the connection means provide for a fluid-tight connection between adjacent slats.

The fluid-tight connection between adjacent slats advantageously allows an optimal condition for creating the desired vacuum in the intermediate depression chambers.

The present invention is further directed to a machine for laser cutting and/or marking sheet material, such as but not limited to carton, paperboard, cardboard, corrugated cardboard, and in general thick paper sheet material comprising a laser apparatus and a conveyor belt according to the invention.

### BRIEF DESCRIPTION OF THE DRAWINGS

The present invention is best understood from the following detailed description when read in conjunction with the accompanying drawing. It is emphasized that, according to common practice, the various features of the drawing are not necessarily to scale. On the contrary, the dimensions of the various features may be arbitrarily expanded or reduced for clarity. Like numerals denote like features throughout the specification and drawing. One or more embodiments of the present invention are now described in greater detail with reference to the accompanying drawings provided by way of non-limiting example.

FIG. 1A is a schematic view of a honeycomb structure according to prior art; FIGS. 1B and 1C are schematic views of two possible embodiments of a working support according to prior art.

FIG. 2A is a cross-section of a working support for supporting and holding sheet material during laser cutting and/or marking operation, according to a possible embodiment of the invention.

FIG. 2B is a cross-section of a slat of a conveyor belt for handling, supporting and holding sheet material during laser cutting and/or marking operation, comprising a working support, according to a possible embodiment of the invention.

FIG. 3 is a perspective view of the honeycomb structure according to an embodiment of the invention.

FIG. 4 is a perspective view of a portion of a slat of a conveyor belt according to an embodiment of the invention.

FIG. 5 is a perspective view of a slat of a conveyor belt provided with a working support according to an embodiment of the invention.

FIG. 6A schematically shows a cross section of a working support according to one embodiment of the invention.

FIG. 6B schematically shows a cross section of a working support according to an embodiment of the invention during use, i.e. when a vacuum element is operated to generate a depression or partial vacuum.

FIG. 7 is schematic side view of an embodiment of a conveyor belt according to the invention.

FIG. 8 is a perspective view of an embodiment of the machine according to the invention.

FIG. 9 is a detail view of an embodiment of the machine according to the invention.

### DETAILED DESCRIPTION

With reference to the figures, a working support 10 for supporting and holding sheet material, such as but not limited to carton, paperboard, cardboard, corrugated cardboard, and in general thick paper sheet material, during laser cutting and/or marking operation, comprises at least one vacuum chamber 1, connected to at least one vacuum element 2, and a honeycomb structure 3, which may be made of metallic material, and comprising a plurality of cells 30. In some embodiments, the honeycomb structure 3 is made of aluminium or steel.

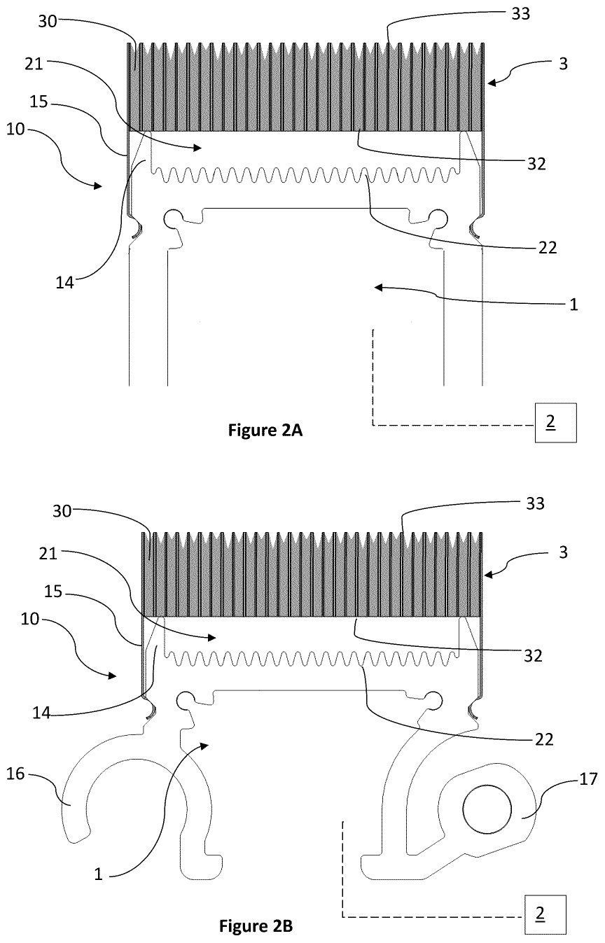

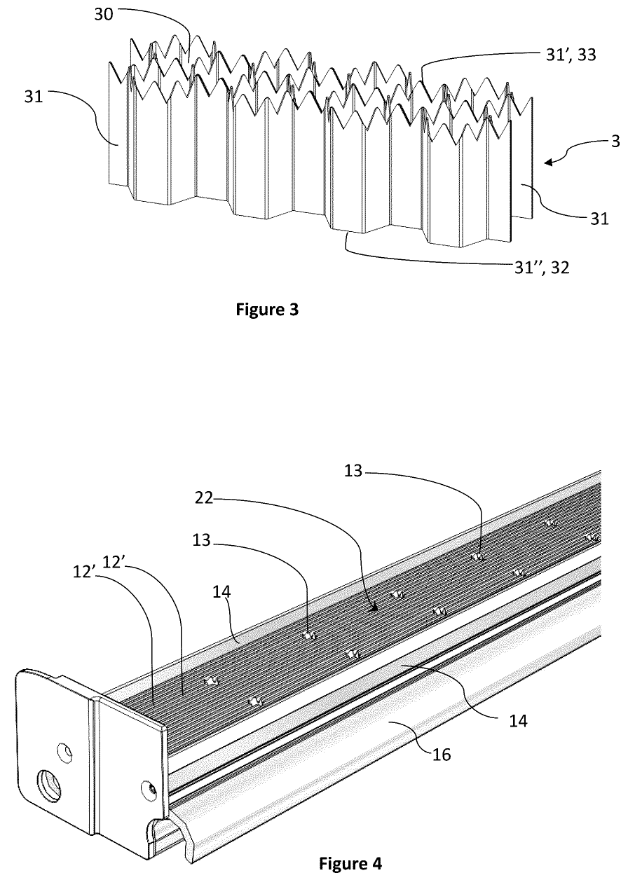

According to one exemplary embodiment, shown by way of example in FIG. 2A, 2B and 3, the upper surface 33 of the honeycomb structure 3 comprises ridges and depressions. It can alternatively be stated that the honeycomb structure has an upper profile defined by, or comprising, ridges and depressions.

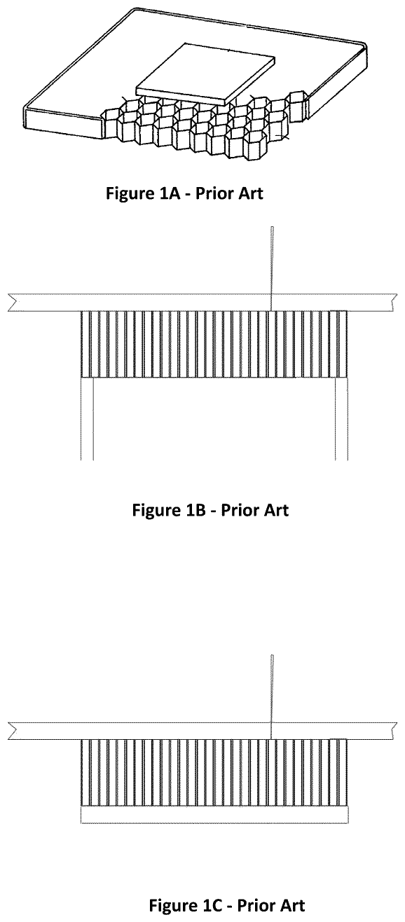

As above, compared to the honeycomb structures known in the art, shown by way of example in FIG. 1A, the presence of a honeycomb structure 3 with an upper surface 33 provided with ridges and depressions allows the sheet material to be not entirely in contact with, i.e. not completely adhering to the honeycomb structure 3 during laser cut, in order to maintain a space between the sheet material and the honeycomb structure 23.

As will be better discussed below, the space generated by the presence of ridges and depressions allows a linear and continuous air flow to be maintained, which avoids turbulence and stagnation of fumes, contrary to the known technique, wherein the honeycomb structure has a flat upper surface (a flat support surface for the sheet material).

With particular reference to FIG. 2A, 2B 6A and 6B, the honeycomb structure 3 is arranged spaced from the vacuum chamber 1, such that the honeycomb structure 3, and in particular the lower surface 32 of the honeycomb structure 3, is arranged at a distance L from the vacuum chamber 1.

It should be noted that the distance L may range from 3 mm to 10 mm, and may be about 6.5 mm in one embodiment.

In other words, the working support 10 comprises an intermediate depression chamber 21, disposed between the vacuum chamber 1 and the lower surface 32 of the honeycomb structure 3.

According to one embodiment, shown as an example in FIGS. 2A, 2B, 4, 5, 6A and 6B, the working support 10 comprises a spacer and support member 14, 15 to support the honeycomb structure 3 such that the lower surface 32 of said honeycomb structure 3 is arranged at a distance L from said lower surface 22 of said intermediate depression chamber 21.

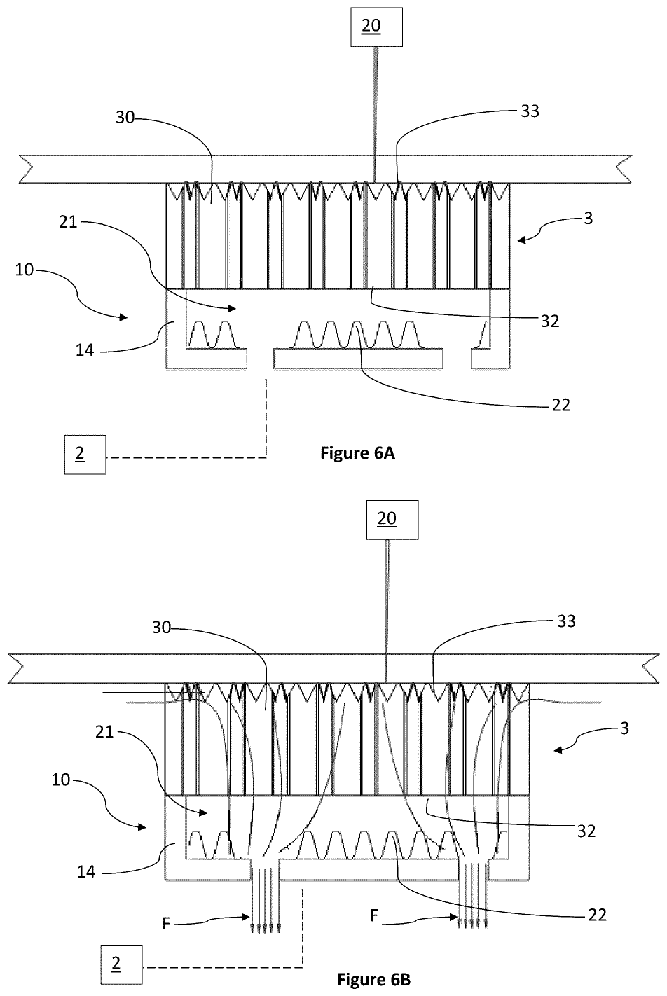

With reference to FIGS. 4, 6A and 6B, the lower surface 22 of the intermediate depression chamber 21 has a plurality of suction holes 13 which fluidically connect the vacuum chamber 1 with the cells 30 of said honeycomb structure 3.

The lower surface 22 of the intermediate depression chamber 21 may be made of metallic material and may be made of aluminium or steel in various advantageous embodiments.

It should be noted that in general the lower surface 22 of the intermediate depression chamber 21 can be made of a material capable of managing the waste energy of the laser, in particular to reflect the residual radiation of the laser beam in such a manner to disperse it. The material may be various metal alloys, ceramics, and suitable composite materials.

According to one embodiment, the suction holes 13 have a diameter of between 2 mm and 8 mm. In one embodiment, the suction holes 13 have a diameter equal to 5 mm.

As shown in FIG. 6A and 6B, suction holes 13 fluidically connect the vacuum chamber 1 with the intermediate depression chamber 21, and with the cells 30 of the honeycomb structure 3.

The working support 10 is typically arranged to support and firmly hold the sheet material, i.e. it is arranged so that, during use, the sheet material is firmly held against the upper surface 33 of the honeycomb structure 3, and in particular it is supported on the ridges of the honeycomb structure 3, i.e. the sheet material does not fully adhere to the upper surface 33 of the honeycomb structure 3. Rather, the sheet material contacts only the ridges of the upper surface 33 of the honeycomb structure, i.e., the sheet material does not lie flat on an upper flat surface of the honeycomb structure. This maintains space between the sheet material and the honeycomb structure 3 to allow for a continuous, linear air flow.

This is obtained via a holding or suction force F, as shown by way of example in FIG. 6B, that draws the sheet material against the upper surface 33 (against the ridges) of the honeycomb structure 3 so that it can be held in the correct working position, during laser cutting or marking operation.

The suction force F is typically a distributed force, i.e. a force that acts on an area, instead of on a single application point. This is exemplified in FIG. 6B, where the arrows representing the suction force F are shown.

Preferably, the suction force F is provided by one or more vacuum elements (aspiration elements) 2.

As an example, a vacuum element 2 schematically shown in FIG. 6A or 6B can be a vacuum pump, and causes a flow of air directed downwards. As a result, a partial depression is caused in the intermediate depression chamber 21, under the honeycomb structure 3, that draws the sheet material against the upper surface 33 (against the ridges) of the honeycomb structure 3.

Other kinds of vacuum elements 2, e.g. aspirators or similar devices or vacuum means, can be used to draw the objects against the working support 10.

It is noted that, for simplicity, elements 2 are called “vacuum” (or aspiration) elements. It is however clear that those elements do not need to create vacuum in the intermediate depression chamber 21 or at the honeycomb structure 3, as a generic depression may be enough to attract the sheet material against the working support 10.

As above mentioned, the lower surface 22 of the intermediate depression chamber 21 is provided with one or more suction holes or apertures 13, such as a plurality of suction holes or apertures 13, through which air can pass. According to a possible embodiment, the honeycomb structure 3 comprises a plurality of corrugated metal sheets 31 welded together, but the metal sheets may be joined together in other manners and using other techniques, according to other embodiments.

Each of the corrugated metal sheets 31 may have an upper profile 31′ provided with ridges and depressions, and a straight lower profile 31″.

In other words, a plurality of corrugated metal sheets 31 with an upper profile 31′ provided with ridges and depressions, and with a straight lower profile 31″are joined together, such as by welding, to form a honeycomb structure 3 with a plurality of cells 30.

It should be noted that the cells 30 have a hexagonal cross section, but square, rectangular, circular (or polygonal in general) cross-sections are other choices available, although hexagonal represents an advantageous embodiment.

According to a possible embodiment, shown by way of example in FIG. 2A and 4, the lower surface 22 of the intermediate depression chamber 21 has a cross-section with a wavy or sinusoidal profile.

As mentioned above, the wavy configuration of the lower surface 22 of the intermediate depression chamber 21 allows the reflections of the laser beam and its excess radiation to disperse after the laser beam and its excess radiation passes through the sheet material and is reflected on the lower surface 22 of the intermediate chamber 21.

In this way, the reflected radiation is dispersed to avoid reflection towards the sheet material being processed, which would lead to unwanted burning or blackening.

With reference to FIG. 2A, a cross-section of the support element 10 is shown, wherein the upper surface of the vacuum chamber 1 is provided with wavy or sinusoidal profile.

According to a possible embodiment, shown by way of example in FIG. 4, the lower surface 22 of the intermediate depression chamber 21 is provided with a plurality of rectilinear grooves 12′, parallel to each other.

According to one aspect of the invention, the working support 10 is coupled to a working table for supporting and holding sheet material, such as carton, paperboard, cardboard, corrugated cardboard, and in general thick paper sheet material during laser cutting and/or marking operation.

In other words, according to various embodiments not shown in the attached figures, the working support 10 is configured to fully or at least partially cover a planar and fixed (not movable) work surface, e.g. a work table connected to a vacuum element or a vacuum platform.

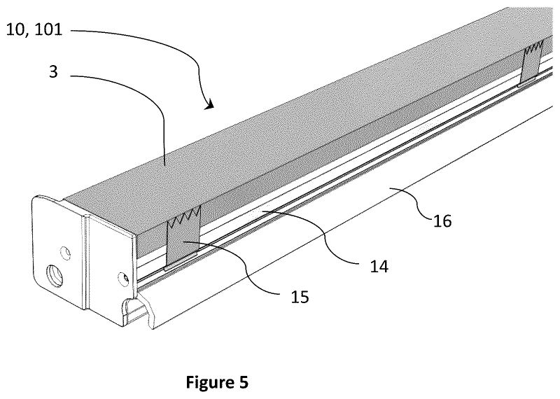

According to a further aspect of the invention, the working support 10 is coupled to (or forms part of) the slats 101 (see FIG. 5) of a conveyor belt (system) 100 for handling, supporting and holding sheet material such as carton, paperboard, cardboard, corrugated cardboard, and in general thick paper sheet material, during laser cutting and/or marking operation.

FIG. 2B also shows the cross-section of a possible embodiment of a slat 101.

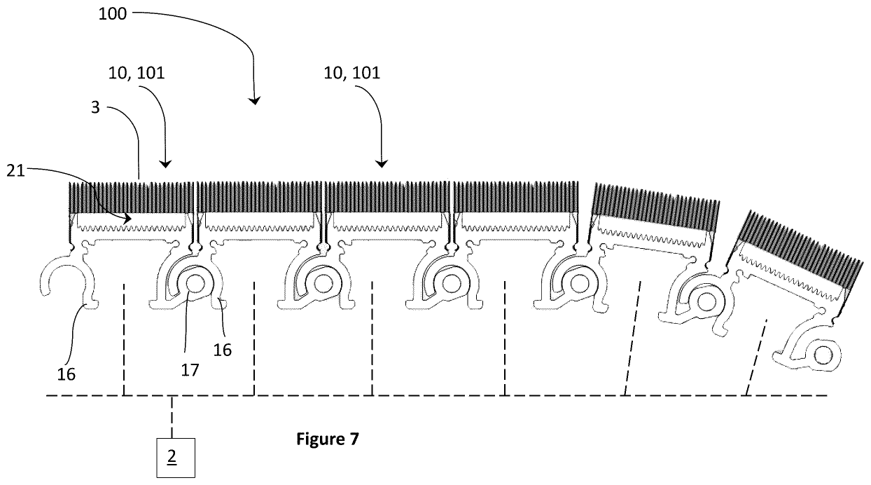

An embodiment of the conveyor belt 100 is for example shown in FIG. 7. In particular, the working support 10 may be coupled to (and become part of) the slats 101 of a pre-existing conveyor belt 100.

The present invention in further directed to a conveyor belt 100 for handling, supporting and holding sheet material such as carton, paperboard, cardboard, corrugated cardboard, and in general thick paper sheet material, during laser cutting and/or marking operation.

With reference to FIG. 7, the conveyor belt 100 according to the invention comprises a plurality of interconnected slats 101 arranged parallel to each other, wherein each slat 101 comprises a working support 10 as described above, connected to at least one vacuum element 2.

The conveyor belt 100 may advantageously be arranged above a vacuum chamber 1, connected to a vacuum generator element 2, and the conveyor belt 100 runs above this vacuum chamber 1, so that each working support 10 of each slat 101 is connected to this vacuum chamber 1 below.

In this way the conveyor belt 100 is configured to provide air suction from the environment, to provide a holding or suction force to hold sheet material.

According to a possible embodiment, shown by way of example in FIG. 2B, each slat 101 is provided with connection elements 16, 17 for interconnection with adjacent slats.

The connection elements 16, 17 advantageously provide for a fluid-tight connection between adjacent slats 101.

In a possible embodiment, each slat 101 is provided with a first connection element 16 which is configured as a hollow tubular profile that may be circular in cross-section, but other shapes as polygonal or elliptical may also be used. With reference to FIGS. 4 and 5, the first connection element 16 runs longitudinally along the main direction of extension of the slat.

It should be noted that each first connection element 16 comprise an aperture that runs longitudinally along the main direction of extension of the connection element 16, in order to allow the insertion and coupling with the second connection element 17 of the adjacent slat 101.

Each slat 101 is further provided with a second connection element 17, which is configured to have a cross-sectional shape complementary to the cross-sectional shape of the first connection element 16 such that second connection element 17 may be received in the opening of first connection element 16.

Thus, the second connection element 17 comprises at least one tubular portion suitable for insertion into the first hollow connection element 16.

In the possible embodiment wherein the working support 10 is coupled to (and become part of) the slats 101 of a pre-existing conveyor belt 100, each slat 101 comprises an intermediate depression chamber 21 with a lower surface 22 which is provided with suction holes 13, which fluidically connect the vacuum chamber 1 with the cells 30 of the respective honeycomb structure 3. According to one embodiment, the lower surface 22 of the intermediate depression chamber 21 of each slat 101 is provided with a number of suction holes 13 that may be between 40 and 80 in number, and having a diameter of between 2 mm and 8 mm, such as 5 mm in one embodiment.

For example, according to a configuration of 60 suction holes per slat 101, each having a diameter equal to 5 mm, and using a vacuum element 2 with a capacity of approximately 4600 m³/h, the following experimental data are obtained.

A depression (relative to atmospheric pressure) of 2500 Pa is created in the vacuum chamber 1 below the conveyor belt 100.

The air velocity inside the suction holes 13 is approximatively 4-5 m/s. In the intermediate depression chamber 21 a depression (relative to atmospheric pressure) of 110-150 Pa is created.

On the working plane, i.e. at the upper surface 33 of the honeycomb structure 3, the air velocity is approximately 0.2-0.3 m/s, and is very homogeneous over the entire surface.

According to an aspect of the invention, the conveyor belt 100 is coupled to (or part of) a machine (system) M for processing the sheet material.

In particular, the conveyor belt 100 may be coupled to (and become part of) a pre-existing machine.

The machine M comprises a conveyor belt 100, for handling, supporting and holding sheet material such as carton, paperboard, cardboard, corrugated cardboard, and in general thick paper sheet material, during laser cutting and/or marking operation.

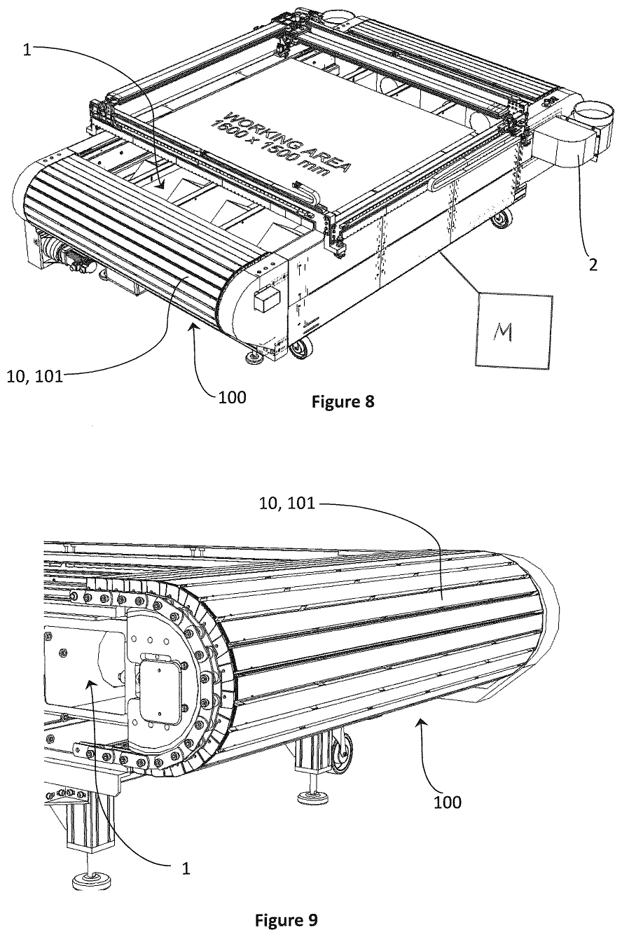

In fact, with reference to FIGS. 8 and 9, the present invention is further directed to a machine M for laser cutting and/or marking sheet material such as carton, paperboard, cardboard, corrugated cardboard, and in general thick paper sheet material comprising a laser apparatus 20 and a conveyor belt 100 as described above.

The conveyor belt 100 of the machine M is typically arranged so as to sustain (support) and hold the sheet material from below in the correct and desired position, i.e. so that the sheet material lies on and proceeds along on the machine conveyor 100.

The conveyor belt 100 of the machine M is advantageously arranged so that the sheet material moves in a horizontal manner, avoiding the lifting movement (i.e. the upward movement against gravity) and transversal movement (i.e. transversal movement with respect to the travel direction of the conveyor).

The sheet material is held against the conveyor belt 100, which is configured (as above described) to generate a machine holding or suction force that holds the sheet material against the conveyor 100. As an example, machine vacuum elements 2 as above described may be provided, as shown in FIG. 8.

The machine M is typically provided with a laser apparatus 20 performing one or more operations on the sheet material, such as cutting, engraving, marking etc.

In particular, the laser apparatus 20 is typically movable in at least two different directions and may be movable in three different directions, so as to follow a predetermined path.

The laser apparatus 20 may be movable at least along a substantially horizontal plane.

After the cut operation (i.e. downstream the cut) the sheet material is thus divided into a plurality of objects, that are surrounded by a waste layer, i.e. the remaining part of the layer that is outside the objects.

A waste collecting device can be placed downstream the laser apparatus. The preceding merely illustrates the principles of embodiments of the disclosure. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A working support (10) for a laser cutting and/or marking operation on sheet material, comprising
at least one vacuum chamber (1) fluidically connected to at least one vacuum element (2);
a honeycomb structure (3) comprising a plurality of cells (30) and disposed spaced from the vacuum chamber (1); and
an intermediate depression chamber (21) disposed between said honeycomb structure (3) and said vacuum chamber (1),
wherein a lower surface (22) of said intermediate depression chamber (21) has a plurality of suction holes (13) which fluidically connect said vacuum chamber (1) with said plurality of cells (30) of said honeycomb structure (3).

2. The working support according to claim 1, wherein the sheet material comprises carton, paperboard, cardboard or corrugated cardboard.

3. The working support (10) according to claim 1, wherein an upper surface (33) of said honeycomb structure (3) comprises ridges and depressions.

4. The working support (10) according to claim 3, wherein the lower surface (22) of said intermediate depression chamber (21) has a cross-section with a wavy or sinusoidal profile.

5. The working support (10) according to claim 1, wherein the lower surface (22) of said intermediate depression chamber (21) comprises a plurality of rectilinear grooves (12′), parallel to each other.

6. The working support (10) according to claim 3, wherein said honeycomb structure (3) comprises a plurality of corrugated metal sheets (31) welded together.

7. The working support (10) according to claim 6, wherein each of said corrugated metal sheets (31) has a straight lower profile (31″).

8. The working support (10) according to claim 1, wherein said honeycomb structure (3) comprises a plurality of corrugated metal sheets (31) welded together.

9. The working support (10) according to claim 8, wherein each of said corrugated metal sheets (31) has an upper surface (33) comprising ridges and depressions, and a straight lower profile (31″).

10. The working support (10) according to claim 1, further comprising a spacer and support member (14, 15) adapted to support said honeycomb structure (3) such that a lower surface of said honeycomb structure (3) is arranged at a distance (L) from said lower surface (22) of said intermediate depression chamber (21).

11. A conveyor belt (100) for handling, supporting and holding sheet material during a laser cutting and/or marking operation, the conveyor belt (100) comprising:
a plurality of interconnected slats (101) arranged parallel to each other, wherein each said slat (101) comprises a working support (10) according to claim 1, each working support (10) being connected to at least one vacuum element (2) configured to provide air suction from the environment, to provide a holding force to hold said sheet material.

12. The conveyor belt (100) according to claim 11, wherein said sheet material comprises carton, paperboard, cardboard or corrugated cardboard.

13. The conveyor belt (100) according to claim 11, wherein each said slat (101) includes connection elements (16, 17) adapted to provide interconnection between adjacent slats.

14. The conveyor belt (100) according to claim 13, wherein said connection elements (16, 17) provide a fluid-tight connection between said adjacent slats (101).

15. A machine (M) for laser cutting and/or marking sheet material comprising carton, paperboard, cardboard and corrugated cardboard,
said machine comprising a laser apparatus (20) and a conveyor belt (100) according to claim 11.
